(19) United States
(12) Patent Application Publication
(10) Pub. No.: US 2008/0297297 A1
(43) Pub. Date: Dec. 4, 2008

(54) CONDUCTIVE WINDING STRUCTURE AND TRANSFORMER HAVING SUCH CONDUCTIVE WINDING STRUCTURE

(75) Inventors: Tsai-Shen Lin, Taoyuan (TW); Zhi-Liang Zhang, Taoyuan (TW); Yu-Chin Lin, Taoyuan (TW)

Correspondence Address: MADSON & AUSTIN, 15 WEST SOUTH TEMPLE, SUITE 900, SALT LAKE CITY, UT, 84101, US

(73) Assignee: Delta Electronics, Inc., Taoyuan (TW)

(21) Appl. No.: 11/950,185

(22) Filed: Dec. 4, 2007

(30) Foreign Application Priority Data
May 29, 2007 (TW) 096119159

(51) Int. Cl. H01F 27/28; H01F 27/32; H01F 5/00; H01F 27/29

(52) U.S. Cl. 336/107; 336/222; 336/223; 336/200

(57) ABSTRACT

A transformer includes a circuit board, a conductive winding structure and a magnetic core assembly. The circuit board has a trace pattern of a primary winding coil and a first through-hole. The first segment has a first pin and a first hollow portion. The second segment has a first end coupled with the first segment, and a second end formed as a second pin and a second hollow portion. The second segment is folded toward the first segment with respect to a folding line such that the first hollow portion and the second hollow portion are aligned with each other to define a second through-hole. The magnetic core assembly is partially embedded into the first through-hole of the circuit board and the second through-hole of the conductive winding structure.

### FIELD OF THE INVENTION

The present invention relates to a conductive winding structure, and more particularly to a conductive winding structure by continuously winding multiple loops of coils. The present invention also relates to a transformer having such a conductive winding structure.

### BACKGROUND OF THE INVENTION

A transformer has become an essential electronic component for voltage regulation into required voltages for various kinds of electric appliances. Referring to FIG. 1, a schematic exploded view of a conventional transformer disclosed in for example U.S. Pat. No. 7,091,817 is illustrated. The transformer 1 of FIG. 1 principally includes a winding frame member 10, a primary winding coil (not shown), multiple conductive pieces 12 and a magnetic core assembly 13. The winding frame member 10 includes a tube structure 101, a first partition plate 102 and a second partition plate 103. The first partition plate 102 is parallel with second partition plate 103. A winding section 104 is defined between the first partition plate 102, the second partition plate 103 and the external surface of the tube structure 101. In addition, bending pieces 105 and 106 are extended from both edges of the first partition plate 102 and the second partition plate 103, respectively. Accordingly, two guiding slots 107 are formed on opposite sides of the winding frame member 10 for accommodating corresponding conductive pieces 12 therein. The magnetic core assembly 13 includes a first magnetic part 131 and a second magnetic part 132. Each conductive piece 12 is a U-shaped copper piece and includes a hollow portion 121 facing the winding member 121. After the conductive pieces 12 are received in the guiding slots 107 and fixed onto the winding frame member 10, the conductive pieces 12 are electrically connected to a circuit board (not shown).

The conductive piece 12 of the transformer 1 is a one-loop structure. Although the one-loop conductive piece 12 may reduce the overall volume of the transformer 1, there are still some drawbacks. For example, the power density is unsatisfied because the total surface area of the conductive pieces 12 is limited. Even if two conductive pieces 12 are combined together to increase the power density, the system board should have corresponding trace pattern for making electrical connection between these two conductive pieces 12. In addition, since the winding frame member 10 is necessary for winding the primary winding coil thereon, the overall volume of the transformer 1 fails to be further reduced. The process of winding the coil is complicated for mass production. Moreover, the winding frame member 10 is only used for winding the coil thereon and providing isolation but fails to participate in the control circuit to transfer control signals.

In views of the above-described disadvantages resulted from the conventional method, the applicant keeps on carving unflaggingly to develop a conductive winding structure and a transformer having such a conductive winding structure according to the present invention through wholehearted experience and research.

### SUMMARY OF THE INVENTION

It is an object of the present invention to provide a conductive winding module to be used as a secondary winding coil of a transformer.

Another object of the present invention provides a conductive winding module for increasing the power density without increasing the overall volume.

A further object of the present invention provides a transformer having such a conductive winding module, in which the transformer is suitable for mass production.

In accordance with an aspect of the present invention, there is provided a conductive winding structure for use in a transformer. The first segment has a first pin and a first hollow portion. The second segment has a first end coupled with the first segment, a second end formed as a second pin and a second hollow portion. The second segment is folded toward the first segment with respect to a folding line such that the first hollow portion and the second hollow portion are aligned with each other to define a through-hole.

In accordance with another aspect of the present invention, there is provided a transformer. The transformer includes a circuit board, a conductive winding structure and a magnetic core assembly. The circuit board has a trace pattern of a primary winding coil and a first through-hole. The first segment has a first pin and a first hollow portion. The second segment has a first end coupled with the first segment, a second end formed as a second pin and a second hollow portion. The second segment is folded toward the first segment with respect to a folding line such that the first hollow portion and the second hollow portion are aligned with each other to define a second through-hole. The magnetic core assembly is partially embedded into the first through-hole of the circuit board and the second through-hole of the conductive winding structure.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view of a conventional transformer;

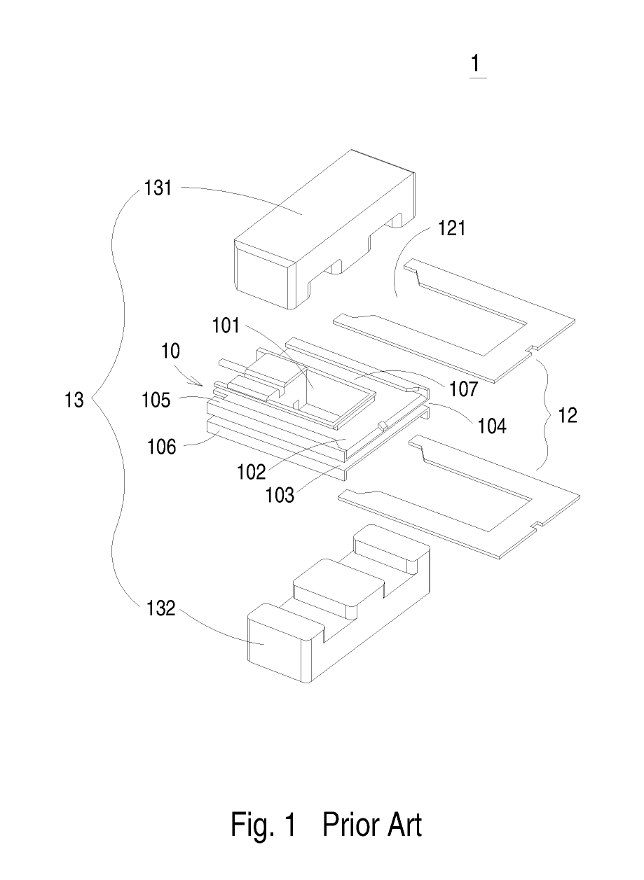

FIG. 2 is a schematic view illustrating a conductive winding module according to a first preferred embodiment of the present invention;

FIG. 3 is a schematic view illustrating a conductive winding module according to a second preferred embodiment of the present invention;

FIG. 4 is a schematic exploded view illustrating a transformer having a conductive winding module of FIG. 2; and

FIG. 5 is a schematic assembled view of the transformer of FIG. 4.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

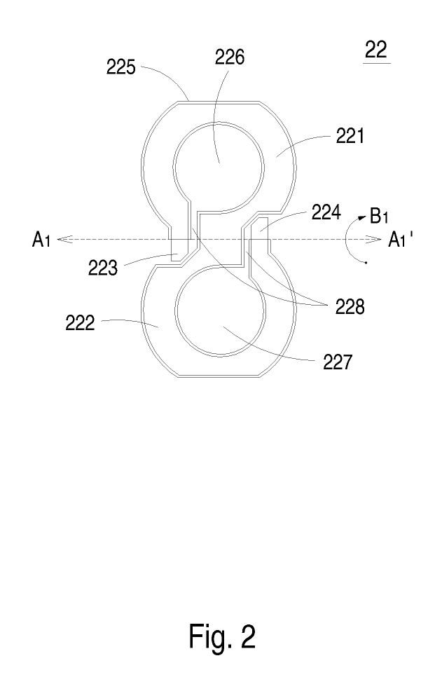

FIG. 2 is a schematic view illustrating a conductive winding module according to a first preferred embodiment of the present invention. The conductive winding module 22 is a single conductive piece made of metallic material such as copper. The conductive winding module 22 principally includes a first segment 221, a second segment 222, a first pin 223 and a second pin 224. The first end of the first segment 221 is coupled to the first end of the second segment 222. The first pin 223 and the second pin 224 are arranged on the second ends of the first segment 221 and the second segment 222, respectively. The conductive winding module 22 further includes an insulating layer 225 sheathed around the first segment 221 and the second segment 222. The first pin 223 and the second pin 224 are not sheathed by the insulating layer 225. The first segment 221 and the second segment 222 have substantially the same profiles. The first pin 223 and the second pin 224 are arranged on opposite sides of the connecting region between the first segment 221 and the second segment 222. In this embodiment, each of the first segment 221 and the second segment 222 is ring-shaped and has a notch 228 in the vicinity of the connecting region. The first segment 221 and the second segment 222 have a first hollow portion 226 and a second hollow portion 227, respectively. The second segment 222 is folded toward the first segment 221 in the direction B1 with respect to the folding line A1A1′ such that the second segment 222 is in contact with or adjacent to the first segment 221. After the folding process, the first hollow portion 226 and the second hollow portion 227 are aligned with each other, and the first pin 223 and the second pin 224 are extended to the same direction. Under this circumstance, the conductive winding module 22, which is an unbroken two-loop conductive piece, is produced.

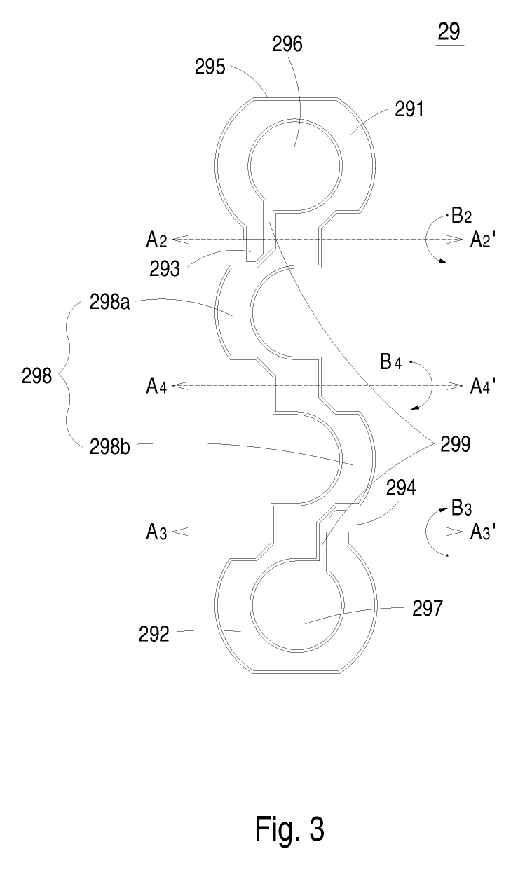

FIG. 3 is a schematic view illustrating a conductive winding module according to a second preferred embodiment of the present invention. The conductive winding module 29 is also a single conductive piece made of metallic material such as copper. The conductive winding module 29 principally includes a first segment 291, a second segment 292, a first pin 293, a second pin 294 and an extension segment 298. The first end of the first segment 291 is coupled with the first terminal of the extension segment 298. The first end of the second segment 292 is coupled with the second terminal of the extension segment 298. The first pin 293 and the second pin 294 are arranged on the second ends of the first segment 291 and the second segment 292, respectively. The conductive winding module 29 further includes an insulating layer 295 sheathed around the first segment 291, the second segment 292 and the extension segment 298. The first pin 293 and the second pin 294 are not sheathed by the insulating layer 295. The extension segment 298 includes a first half extension part 298a and a second half extension part 298b. The first half extension part 298a and the second half extension part 298b are coupled to the first segment 291 and the second segment 292, respectively. The first half extension part 298a and the second half extension part 298b have substantially the same semi-ring profiles.

Please refer to FIG. 3 again. The first segment 291 and the second segment 292 have substantially the same profiles. In this embodiment, each of the first segment 291 and the second segment 292 is ring-shaped and has a notch 299 in the vicinity of the connecting region between the first segment 291 and the first half extension part 298a and in the vicinity of the connecting region between the second segment 292 and the second half extension part 298b. The first segment 291 and the second segment 292 have a first hollow portion 296 and a second hollow portion 297, respectively. The first segment 291 is folded toward the first half extension part 298a in the direction B2 with respect to the folding line A2A2′ such that the first segment 291 is in contact with or adjacent to the first half extension part 298a. The second segment 292 is folded toward the second half extension part 298b in the direction B3 with respect to the folding line A3A3′ such that the second segment 292 is in contact with or adjacent to the second half extension part 298b. In addition, the first half extension part 298a is folded toward the second half extension part 298b in the direction B4 with respect to the folding line A4A4′ such that the first half extension part 298a is in contact with or adjacent to the second half extension part 298b.

After the folding process, the first half extension part 298a and the second half extension part 298b is formed as a ring-shaped structure having a central hollow portion, which is aligned with the hollow portion 296 of the first segment 291 and the hollow portion 297 of the second segment 292. In addition, the first pin 293 and the second pin 294 are extended to the same direction. Under this circumstance, the conductive winding module 29, which is an unbroken three-loop conductive piece, is produced.

It is noted that, however, those skilled in the art will readily observe that numerous modifications and alterations may be made while retaining the teachings of the invention. For example, the conductive winding module of the present invention may be an unbroken conductive piece having more than three loops. In addition, the conductive winding module may have arbitrary shape such as a rectangular shape.

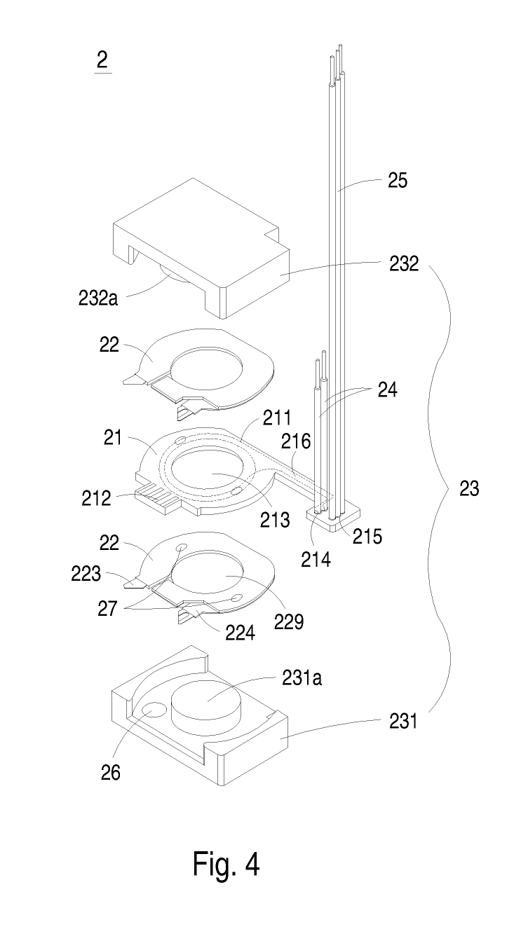

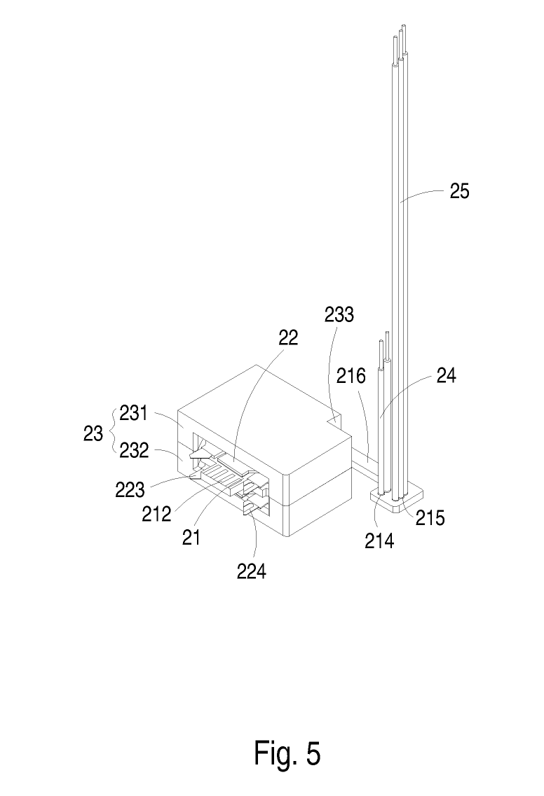

FIG. 4 is a schematic exploded view illustrating a transformer having a conductive winding module of FIG. 2. FIG. 5 is a schematic assembled view of the transformer of FIG. 4. As shown in FIGS. 4 and 5, the transformer 2 principally includes a circuit board 21, at least one conductive winding module 22 and a magnetic core assembly 23. The circuit board 21 is mainly a ring-shaped structure having a through-hole 213 in the center thereof. In addition, the circuit board 21 has a protrusion 216 extended from a side thereof. A primary winding coil 211 is formed as a trace pattern within the circuit board 21, and both terminals of the primary winding coil 211 are connected to power contacts 214. The power contacts 214 are further electrically connected to a power source (not shown) through wires 24 so as to transmit the input power to the circuit board 21. Moreover, the circuit board 21 has a signal connection interface 212 (e.g. an edge connector). The signal connection interface 212 is electrically connected to signal contacts 215 through specified trace pattern (not shown). The signal connection interface 212 may be inserted into a corresponding slot of a system board (not shown) so that the control signals may be transmitted to the control circuit of the system board through the signal wires 25, the signal contacts 215 and the signal connection interface 212. It is preferred that the power contacts 214 and the signal contacts 215 are arranged on the protrusion 216 of the circuit board 21 in order to provide a desired electrical safety distance.

Please refer to FIGS. 2, 4 and 5. After the second segment 222 is folded toward the first segment 221 in the direction B1 with respect to the folding line A1A1′, the first hollow portion 226 and the second hollow portion 227 are aligned with each other to form a through-hole 229. For assembling the transformer 2, the at least one conductive winding module 22 is placed on the circuit board 21 such that the first pin 223 and the second pin 224 are extended in the same direction as the signal connection interface 212. The first pin 223 and the second pin 224 will be welded on corresponding soldering contacts on the system board. Since the first pin 223 and the second pin 224 are made of for example copper and are relatively thin, the first pin 223 and the second pin 224 need to be reinforced. For example, the first pin 223 and the second pin 224 may be punched to form bending parts (not shown) for facilitating fixing the pins on the system board.

The magnetic core assembly 23 includes a first magnetic part 231 and a second magnetic part 232. The first magnetic part 231 and the second magnetic part 232 of the magnetic core assembly 23 are cooperatively formed as an EE-type core assembly. The middle portions 231a and 232a of the first magnetic part 231 and the second magnetic part 232 are partially embedded into the through-hole 229 of the conductive winding module 22 and the through-hole 213 of the circuit board 21. As a result, the primary winding coil 211 of the circuit board 21 and the secondary winding coil (i.e. the conductive winding module 22) interact with the magnetic core assembly 23 to achieve the purpose of voltage regulation. In some embodiments, the magnetic core assembly 23 has an aperture 233 for the protrusion 216 of the circuit board 21 to penetrate therethough, thereby providing a desired electrical safety distance.

For facilitating securely assembling the transformer 2, the inner surfaces of the first magnetic part 231 and the second magnetic part 232 are bonded onto the conductive winding module 22 via adhesives 26. Similarly, the conductive winding modules 22 are bonded onto the circuit board 21 via adhesives 27.

From the above description, the conductive winding module of the present invention may be used as the secondary winding coil of the transformer. Since the conductive winding module is an unbroken multi-loop conductive piece, the overall volume of the conductive winding module is reduced. As the loop number of the conductive winding module is increased, the power density is increased. Moreover, since the primary winding coil is buried within the circuit board, the overall volume of the transformer will be further reduced and the transformer is suitable for mass production. Via the signal connection interface of the circuit board, the transformer will be communicated with the system board to transfer control signals.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A conductive winding structure for use in a transformer, the conductive winding structure comprising:
a first segment having a first pin and a first hollow portion; and
a second segment having a first end coupled with the first segment, a second end formed as a second pin and a second hollow portion, wherein the second segment is folded toward the first segment with respect to a folding line such that the first hollow portion and the second hollow portion are aligned with each other to define a through-hole.

2. The conductive winding structure according to claim 1 wherein the conductive winding structure is a single and unbroken two-loop conductive piece made of metallic material.

3. The conductive winding structure according to claim 1 wherein each of the first segment and the second segment has a ring-shaped profile with a notch, and the first pin and the second pin are arranged on opposite sides of the connecting portion between the first segment and the second segment.

4. The conductive winding structure according to claim 1 wherein the first and the second segments are sheathed by an insulating layer, and the first and the second pins are unsheathed by the insulating layer.

5. The conductive winding structure according to claim 1 wherein the second segment is coupled with the first segment through an extension segment.

6. The conductive winding structure according to claim 5 wherein the extension segment includes at least one pair of half extension parts, which have the same profiles.

7. The conductive winding structure according to claim 6 wherein each of the first segment and the second segment has a ring-shaped profile with a notch, and the half extension parts of the extension segment have substantially the same semi-ring profiles.

8. The conductive winding structure according to claim 7 wherein each pair of the half extension parts of the extension segment are folded with each other to form a ring-shaped profile.

9. The conductive winding structure according to claim 8 wherein the conductive winding structure is an unbroken three-loop conductive piece.

10. A transformer comprising:
a circuit board having a trace pattern of a primary winding coil and a first through-hole;
a conductive winding structure including a first segment and a second segment, the first segment having a first pin and a first hollow portion, the second segment having a first end coupled with the first segment, a second end formed as a second pin and a second hollow portion, wherein the second segment is folded toward the first segment with respect to a folding line such that the first hollow portion and the second hollow portion are aligned with each other to define a second through-hole; and
a magnetic core assembly partially embedded into the first through-hole of the circuit board and the second through-hole of the conductive winding structure.

11. The transformer according to claim 10 wherein the circuit board further includes:
multiple power contacts electrically connected to the primary winding coil;
a signal connection interface to be mounted on a system board; and
multiple signal contacts electrically connected to the signal connection interface.

12. The transformer according to claim 11 wherein the signal connection interface is an edge connector.

13. The transformer according to claim 11 wherein the circuit board further includes a protrusion, and the power contacts and the signal contacts are arranged on a terminal of the protrusion.

14. The transformer according to claim 10 wherein the conductive winding structure is a single and unbroken two-loop conductive piece made of metallic material.

15. The transformer according to claim 10 wherein each of the first segment and the second segment has a ring-shaped profile with a notch, and the first pin and the second pin are arranged on opposite sides of the connecting portion between the first segment and the second segment.

16. The transformer according to claim 10 wherein the first and the second segments are sheathed by an insulating layer, and the first and the second pins are unsheathed by the insulating layer.

17. The transformer according to claim 10 wherein the second segment is coupled with the first segment through an extension segment, and the extension segment includes at least one pair of half extension parts, which have the same profiles.

18. The transformer according to claim 17 wherein each of the first segment and the second segment has a ring-shaped profile with a notch, and the half extension parts of the extension segment have substantially the same semi-ring profiles.

19. The transformer according to claim 18 wherein each pair of the half extension parts of the extension segment are folded with each other to form a ring-shaped profile.

20. The transformer according to claim 19 wherein the conductive winding structure is a single and unbroken three-loop conductive piece made of metallic material.
